(19) United States
(12) Patent Application Publication
(10) Pub. No.: US 2006/0274144 A1
(43) Pub. Date: Dec. 7, 2006

(54) Communications device with a visual ring signal and a method of generating a visual signal

(75) Inventors: Assaf Landschaft, Munich (DE); Gal Wohlstadter, Munich (DE); Gil Wohlstadter, Munich (DE)

Correspondence Address: HITT GAINES, PC;AGERE SYSTEMS INC., PO BOX 832570, RICHARDSON, TX, 75083, US

(73) Assignee: Agere Systems, Inc., Allentown, PA (US)

(21) Appl. No.: 11/143,911

(22) Filed: Jun. 2, 2005

(51) Int. Cl. H04N 7/14

(52) U.S. Cl. 348/14.01

(57) ABSTRACT

A communications device that generates a visual ring signal as an indication of an incoming call and a method of generating a visual ring signal for a communications device. In one embodiment, the method includes generating a digital representation of an audio sequence and displaying a sequence of visual effects based on the digital representation.

### TECHNICAL FIELD OF THE INVENTION

The present invention is directed, in general, to a wireless communications device and, more specifically, to a communications device with a visual ring signal and a method for visually indicating an incoming call on a communications device.

### BACKGROUND OF THE INVENTION

The functionality of communication devices, in particular mobile communication devices like mobile phones, continues to steadily increase. This is especially the case with the implementation of a large variety of ring tones, which have become a very popular option for users. Polyphonic ring tones have become standard fare in nearly all the mobile phones now being marketed.

Providers are also offering increasingly complex ring tones that can be downloaded. For example, US Patent Application No. 2003/0162571A1 entitled MOBILE PHONE ACCESSORY FOR PROVIDING MULTI-CHORD RING TONES, Chung, Je-Hwan, discloses a mobile phone accessory adapted to a music file as a multi-chord ring tone in response to a call reception signal. Even more realistic music output can be obtained with today's mobile communication devices because of the quality of MP3 players.

In some cases and for certain purposes, attempts have been made to correlate music to visual elements. In U.S. Pat. No. 6,411,289 B1 to Zimmerman, for instance, a method is disclosed for providing a three dimensional illustration of a musical work wherein, for each sound of a musical work, its tone, harmony and tonality is determined. A value is assigned to each of these characteristics in the musical work so they can be displayed on a three-dimensional graph having a time axis, a tone axis and a harmony axis. This musical visualization is intended to make certain aspects of complex musical compositions visible. In U.S. Pat. No. 6,725,108 B1 to Hall a system and method for the interpretation and visualization of acoustic spectra is described that provides for analyzing the spectra of musical sounds in order to extract pitch and timbre.

The use of a visual output to notify a communications device user of a ring signal is still limited to displaying the number and/or the name of the calling party. On the other hand, a wide variety of audio signals are available to notify a communications device user of an incoming call. In certain situations, such as in a meeting or when in situations or locations where an audio ring signal is deemed to be inappropriate, a visual ring signal may be preferred. However, in the visual domain, a user of a communications device still does not have a means to personalize an incoming call signal on his or her communications device.

Accordingly, what is needed in the art is a new and improved approach to visual signaling on a communications device; especially with respect to the indication of an incoming call signal, particularly with respect to an incoming call signal on a mobile communications device.

### SUMMARY OF THE INVENTION

To address the above-discussed deficiencies of the prior art, the present invention provides for a method of generating a visual ring signal for a communications device and a communications device with a visual ring signal indicating an incoming call. In one embodiment, the method includes generating a digital representation of an audio sequence and displaying a sequence of visual effects based on the digital representation.

The present invention thus advantageously enables the user of a communications device to customize and enhance the way the device alerts him or her to an incoming call signal by providing visual effects in addition to, or instead of, a ring tone and/or a vibration. This enables a user to distinguish his or her communications device from other similar communication devices when a call is received. Preferably, the visual effects will be provided simultaneously with the audio alert signal integral to the communications device.

In one embodiment of the invention, the audio output sequence of the communications device signal is from an audio output means integrated in the communications device. In another embodiment, the method provides for the generation of a digital representation by a spectral analysis for evaluating a frequency content of the audio sequence. A further aspect of this embodiment provides for the spectral analysis to be performed at one or more discrete evaluation frequencies. In yet another embodiment of the invention, the visual effects comprise visual elements representing a frequency spectrum of the audio sequence. In yet still another embodiment of the invention, the method provides for the generation of the digital representation based on analyzing a tone, a harmony and/or a tonality of the sounds of the audio sequence.

In one embodiment of the invention, a method of displaying the visual signal by a display means integrated in the communications device is provided for. In another embodiment of the method, the visual effects consist of geometric shapes and/or fractals. In yet another embodiment, the audio sequence is music. In still another embodiment, a method provides for the visual effects to consist of a series of images depicting a visualization of a person dancing. In yet still another embodiment, the invention provides for displaying the visual effects by means of at least one light emitting device (LED) integrated in the communications device. A particularly useful embodiment of the invention provides for the communications device to be a mobile communications device.

The invention also provides for several embodiments of a communications device that has a visual display with a visualization generator for generating a digital representation of an audio sequence and a visualization controller for displaying a sequence of visual effects based on the digital representation. The invention also provides for a visual ring signal control device that has a digital storage medium of electronically readable control instructions and an associable communications device. The digital storage medium is adapted to execute, when associated with the communications device, control instructions to display a sequence of visual effects based on a digital representation of an audio sequence. One embodiment of the storage medium is a microchip.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawings, in which:

FIG. 1 illustrates a frontal plan view of a communications device constructed in accordance with the present invention wherein a visual signal is displayed in response to a ring signal received by the device;

FIG. 2 illustrates a block diagram of a communications device incorporating an embodiment of the present invention; and

FIGS. 3a-3c illustrate various embodiments of a visual response to a ring signal received by a communications device.

### DETAILED DESCRIPTION

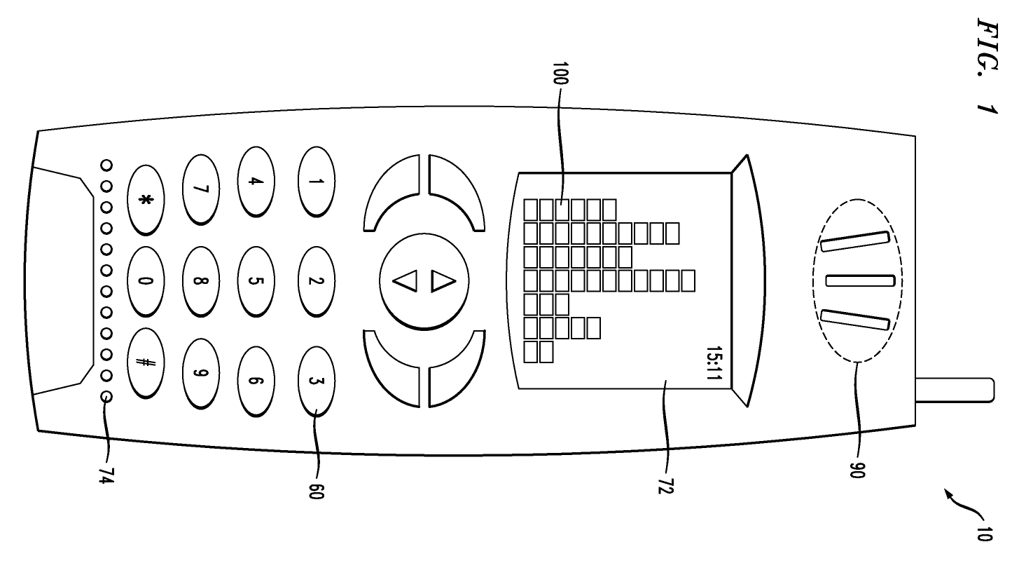

Referring initially to FIG. 1, illustrated is a frontal plan view of a communications device 10 constructed in accordance with the present invention wherein a visual signal 100 is displayed in response to a ring signal received by the device 10. The illustrated embodiment is a mobile communication device 10 with a screen 72 used as the primary means for displaying a visual signal 100. Also illustrated is a secondary visual signal display means, which is a row of LEDs 74 integrated into the communications device 10. Those of ordinary skill in the pertinent art will recognize that, alternatively, the LEDs 74 could also be arranged in such a way as to illuminate the keys of the keypad 60.

A speaker 90 is shown that, in certain embodiments of the invention, is adapted to provide a music signal in response to the receipt of a ring signal. In the illustrated embodiment, the response to the ring signal also includes a visual signal 100 that will be correlated with the music played in response to the ring signal. In the instant case, the visual signal 100 is made up of a power spectrum with bars representing different frequency ranges of the music.

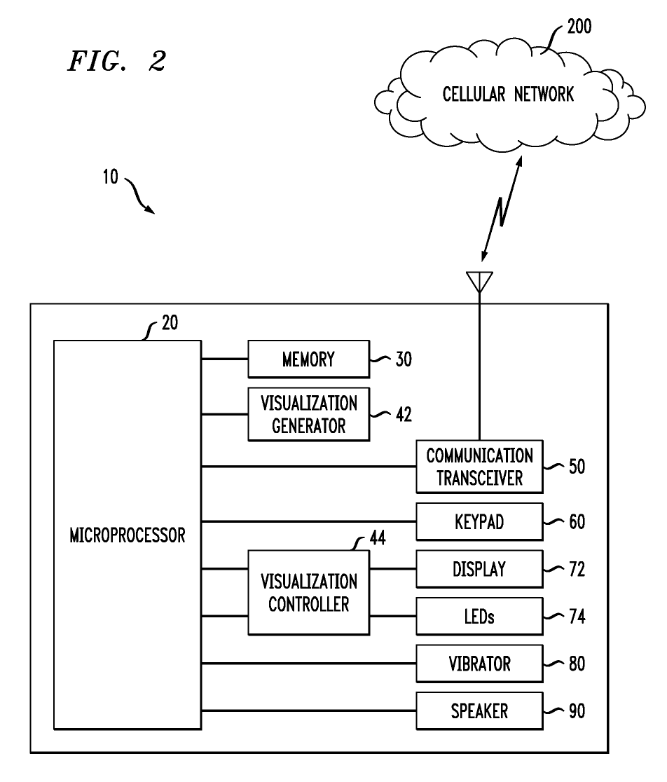

Turning now to FIG. 2, illustrated is a block diagram of a mobile communications device 10 incorporating an embodiment of the present invention. The illustrated mobile communications device 10 shows the various components, which are controlled by a micro-processor 20. To connect to a cellular network 200, the mobile phone 10 has an integrated communication transceiver 50. In the memory 30 of the mobile communications device certain settings are stored, defining which one of a plurality of music files, which are also stored in the memory 30, is to be played in the event of an incoming call. The settings can be set to provide for different music files to be played depending on the phone number of the calling party.

When a call signal is received a music file is retrieved from the memory 30, with the specific file depending on the settings in the memory 30, and a visualization generator 42 generates a digital representation of the retrieved music file. Simultaneously with the signal provided by the music file being played over the loudspeaker 90, a visual signal 100 is displayed by means of the integrated display screen 72 and/or the integrated LEDs 74. The visual signal can be controlled by means of a micro-processor 20 alone or by means of a dedicated visualization controller 44. The visualization controller 44 is most preferably utilized when the controlled output means are used solely for visual alerting purposes such as, for instance, by the LEDs 74. As is the case with most mobile communications devices 10, it also has a vibrator 80 means that will cause a vibration signal to be provided in response to an incoming call signal. When a user responds to an incoming call signal by pressing the appropriate key on the keypad 60 to accept the call, all the incoming call signals, visual, audio and vibration, will be terminated.

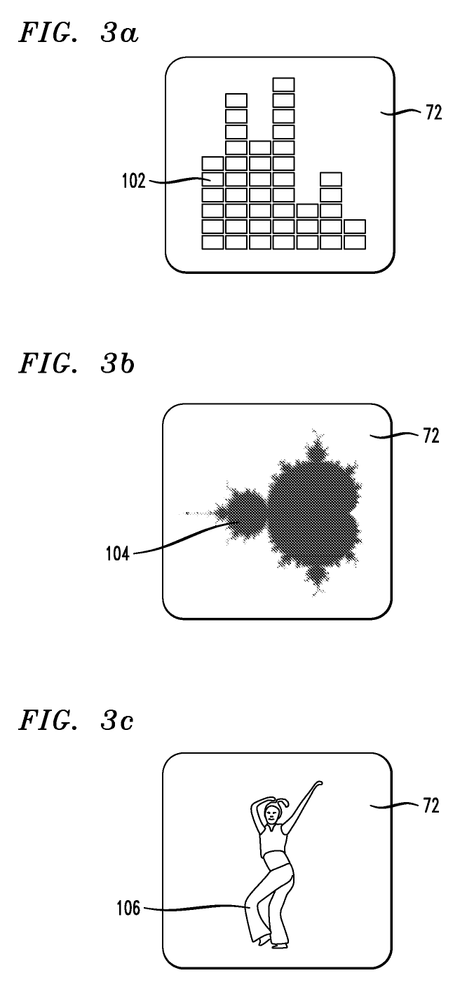

Turning now to FIGS. 3a-3c, illustrated are various embodiments of a visual response to a ring signal received by a communications device 10. Regardless of the type of communications device utilizing the present invention, the visual signal 100 displayed in response to the ring signal will be displayed by means of a display screen 72, which may or may not be integrated into the device 10.

Illustrated in FIG. 3a is a visual signal 102 which depicts a power spectrum 102 with bars that represent the intensity in different frequency ranges of the sampled sound of music or other audio ring signal. Illustrated in FIG. 3b are fractals 104 which change their shape and/or color in correlation to the sampled music or other audio signal. FIG. 3c illustrates an embodiment of the invention where the visual ring signal 106 is a person dancing. In the instant case it is a depiction of a woman dancing to the rhythm of the sampled music, although, as will be understood by those skilled in the pertinent art, it could be a depiction of any object that provides a visual ring signal in correlation to the music. For example, it could be a moving dog or other animal or even an inanimate object such as an airplane or sailboat.

As will be understood by those of ordinary skill in the relevant art, the invention described herein enables the user of a communications device to customize and enhance the way the device alerts the user of an incoming call by providing visual effects, in addition to, or even instead of, an audible ring signal and/or a vibratory signal. The present invention usefully permits a personal communications device to be more easily distinguishable from other similar communication devices when an incoming call signal is received.

There are a number of ways a digital representation can be obtained from an audio sequence so as to result in a sequence of numbers representing at least one characteristic of the sounds in the audio sequence. One method to generate such a digital representation is to evaluate the frequency content of the audio sequence by means of spectral analysis. Advantageously, such a spectral analysis can be performed to evaluate a frequency content of an audio sequence at one or more discrete evaluation frequencies. Another method to generate digital representation of an audio sequence is to analyze the tone, the harmony and/or the tonality of the sounds of the audio sequence.

A virtually inexhaustible number of visual effects can be generated by means of the number sequence of the digital representation obtained from an audio sequence. The visual effects can, for example, be any kind of geometric shapes which alter their size, shape or color corresponding to the audio sequence or by changing fractals. In the case of a spectral analysis of an audio sequence, the visual effects can also be the visualization of a synthesizer with bars representing different frequencies or frequency ranges. In the case of an audio sequence being a piece of music where the visual signal representing such music is a series of images depicting a dancing person, such audio sequence can also depict any other object or thing and be within the intended scope of the present invention.

The visual signals produced by the foregoing examples are preferably displayed by means of a display screen integrated into the communication device in the case of a mobile communications device. However, such a limitation is not necessary in the case of a communications device that is not mobile. For example, a residential telephone can be hooked up to a television set to depict a visual signal to an incoming call signal. Of course, an additional alternative to display a visual call signal is to utilize at least one light emitting device (LED) integrated in or associated with the communications device.

A communication device utilizing the present invention, in particular a mobile communications device 10, will have an audio output means 90, a visual output means 72, 74, a visualization generator 42 for generating a digital representation of an audio sequence, and a visualization controller 44 for displaying a sequence of visual effects, depending on the selected digital representation.

In one embodiment of the present invention, to evaluate the frequency content of an audio sequence that will be visualized; a communications device will have a spectral analyzing means. To analyze the tone, the harmony and/or the tonality of the sounds of the audio sequence, the communications device will have a tone analyzing means.

In order to provide a visual signal, a mobile communications device constructed in accordance with the present invention will be provided with an integrated display screen 72. A particularly useful embodiment will provide for an integrated color display screen. Alternatively, or additionally, the communications device will also be provided with at least one LED 74. For the display of more complex visual effects the communications device will be advantageously be provided with a plurality of LEDs 74 of different colors.

In one embodiment of the invention, the audio sequence will be a musical work and the communication device will be provided with an audio output means that is adapted to play such musical work. In the case of a musical audio signal, the visualization generator and/or the visualization controller will be adapted to generate a series of images depicting the visualization of a dancing person 106 or other moving object, which moves in correlation to the music.

Mobile communications devices are generally provided with selectable musical ring tones and, typically, with application programming interfaces (APIs) for detecting incoming calls and selecting the appropriate ring tone. Therefore, the new functionality provided by the present invention of generating a visual signal based on a musical ring tone can also be implemented by means of software which uses existing APIs. Accordingly, the present invention also provides for a digital storage medium, in particular a microchip, with electronically readable control instructions adapted to execute a method as described above, when associated with a mobile communications device.

Although the present invention has been described in detail, those skilled in the art should understand that they can make various changes, substitutions and alterations herein without departing from the spirit and scope of the invention in its broadest form.

1. A method of generating a visual ring signal for a communications device, comprising:
detecting a ring signal with a communications device;
generating a digital representation of an audio sequence of said ring signal; and
displaying, on a visual display integrated in said communications device, a sequence of visual effects based on said digital representation.

2. The method as recited in claim 1 further comprising outputting said audio sequence with an audio output means integrated in said communications device.

3. The method as recited in claim 1 wherein said generating a digital representation comprises a spectral analysis for evaluating a frequency content of said audio sequence.

4. The method as recited in claim 3 wherein said spectral analysis is performed at one or more discrete evaluation frequencies.

5. The method as recited in claim 1 wherein said visual effects comprise visual elements representing a frequency spectrum of said audio sequence.

6. The method as recited in claim 1 wherein generating said digital representation comprises analyzing a tone, a harmony and/or a tonality of sounds of said audio sequence.

7. (canceled)

8. The method as recited in claim 1 wherein said visual effects consist of geometric shapes and/or fractals.

9. The method as recited in claim 1 wherein said audio sequence is music.

10. The method as recited in claim 9 wherein said visual effects consist of a series of images depicting a visualization of a person dancing.

11. The method as recited in claim 1 wherein displaying of said visual effects is by means of at least one light emitting device (LED) integrated in said communications device.

12. The method as recited in claim 1 wherein said communications device is a mobile communications device.

13. A communications device, comprising:
a visual display integrated in said communications device;
a visualization generator, integrated within said communications device, for generating a digital representation of an audio sequence; and
a visualization controller for displaying a sequence of visual effects on said visual display based on said digital representation

14. The communications device as recited in claim 13 further comprising a spectral analyzing means for evaluating a frequency content of said audio sequence.

15. The communications device as recited in claim 13 further comprising a tone analyzing means for analyzing a tone, a harmony and/or a tonality of sounds of said audio sequence.

16. (canceled)

17. The communications device as recited in claim 13 wherein said visual display comprises at least one integrated light emitting device (LED).

18. The communications device as recited in claim 13 further comprising an audio output means adapted for music.

19. The communications device as recited in claim 13 wherein said visual display depicts a person dancing.

20. The communications device as recited in claim 13 wherein said communications device is a mobile communications device.

21. A visual ring signal control device, comprising:
a digital storage medium of electronically readable control instructions for said visual ring signal control device; and
a communications device associable with said digital storage medium, said digital storage medium adapted to execute, when associated with said communications device, control instructions to display a sequence of visual effects based on a digital representation of an audio sequence detected by said communications device.

22. The visual ring signal control device as recited in claim 21 wherein said digital storage medium is a microchip.
